(19) United States
(12) Patent Application Publication
(10) Pub. No.: US 2016/0081299 A1
(43) Pub. Date: Mar. 24, 2016

(54) Pet Confinement Apparatuses and Methods

(71) Applicant: Susan J. Wesley, Huntsville, AL (US)

(72) Inventor: Susan J. Wesley, Huntsville, AL (US)

(21) Appl. No.: 14/861,689

(22) Filed: Sep. 22, 2015

Related U.S. Application Data
(60) Provisional application No. 62/053,485, filed on Sep. 22, 2014.

(51) Int. Cl. A01K 1/03; A01K 1/035

(52) U.S. Cl. CPC A01K 1/03; A01K 1/035

(57) ABSTRACT

A pet confinement apparatus of the present disclosure has a cage with a front member, a back member, a top member, a first and second side member, and a floor. The members and the floor define a confinement area for confining a pet. The pet confinement apparatus further has a hammock that has a plurality of straps. A portion of the straps are coupled to a top horizontal rail of the front member and a top horizontal rail of the first side member. A portion of the straps are coupled to the back member, and each strap is coupled to a horizontal rail of the back member that is closer to the floor than the horizontal member to which the previous strap is attached. Further, a portion of the straps are longer in length that the other straps and at least two of the longer straps are coupled to a horizontal rail in the top member so that the hammock hangs forming a declivity and acclivity that allows ingress to and egress from the hammock by the pet.

### CROSS-REFERENCE TO RELATED APPLICATIONS

This application claims priority to U.S. Provisional Patent Application Ser. No. 62/053,485 entitled Hanging Pet Hammock Apparatuses and Methods and filed on Sep. 22, 2014, which is incorporated herein by reference.

### BACKGROUND

Oftentimes, a pet owner needs a way to confine their pet. Confinement may assist the pet owner in a number of ways. For example, confinement may allow the pet owner to potty-train their pet. Additionally, pet owners may find it necessary to leave their pet for a period of time, and the pet owner may be concerned that the pet will cause destruction in the house, e.g., chew furniture or eliminate on the floor.

One such confinement method used readily by pet owners is a cage. Pets tend to refrain from soiling their sleeping quarters. Thus, they typically do not eliminate in the cage if let out at appropriate times. Thus, the pet owner confines the pet to the cage, and periodically releases the pet outside where the pet can eliminate.

Unfortunately, most cages do not have a considerable amount of space in which the pet may rest. The space in which the pet may rest is limited to the floor of the cage.

### SUMMARY

A pet confinement apparatus of the present disclosure has a cage with a front member, a back member, a top member, a first and second side member, and a floor. The members and the floor define a confinement area for confining a pet. The pet confinement apparatus further has a hammock that has a plurality of straps. A portion of the straps are coupled to a top horizontal rail of the front member and a top horizontal rail of the first side member. A portion of the straps are coupled to the back member, and each strap is coupled to a horizontal rail of the back member that is closer to the floor than the horizontal member to which the previous strap is attached. Further, a portion of the straps are longer in length that the other straps and at least two of the longer straps are coupled to a horizontal rail in the top member so that the hammock hangs forming a declivity and acclivity that allows ingress to and egress from the hammock by the pet.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a perspective view of an exemplary L-shaped hammock in accordance with an embodiment of the present disclosure.

FIG. 2 is a perspective view of an exemplary pet confinement apparatus in accordance with an embodiment of the present disclosure in which is installed the hammock of FIG. 1.

FIG. 3 is a top view of the confinement apparatus as depicted in FIG. 2.

FIG. 4 is an end view of the confinement apparatus as depicted in FIG. 2.

FIG. 5 is a front view of the confinement apparatus as depicted in FIG. 2.

FIG. 6 is another end view of the confinement apparatus as depicted in FIG. 2.

FIG. 7 is a back view of the confinement apparatus as depicted in FIG. 2.

FIG. 8 is a perspective view of an exemplary bed as depicted in FIG. 1.

### DETAILED DESCRIPTION

The present disclosure describes pet confinement apparatuses and methods. The confinement apparatus of the present disclosure comprises a cage. Within the cage is a hammock that couples to the rails of the cage. In one embodiment, the hammock is L-shaped. One end of the hammock is coupled on a first side of the cage a first distance from the floor of the cage. In one embodiment, the first distance is from the floor of the cage to an edge of the hammock. A second end of the hammock is coupled on a second side of the cage a second distance from the floor of the cage. The first distance is greater than the second distance causing a droop or sage in the hammock for ingress to and egress from the hammock by a pet.

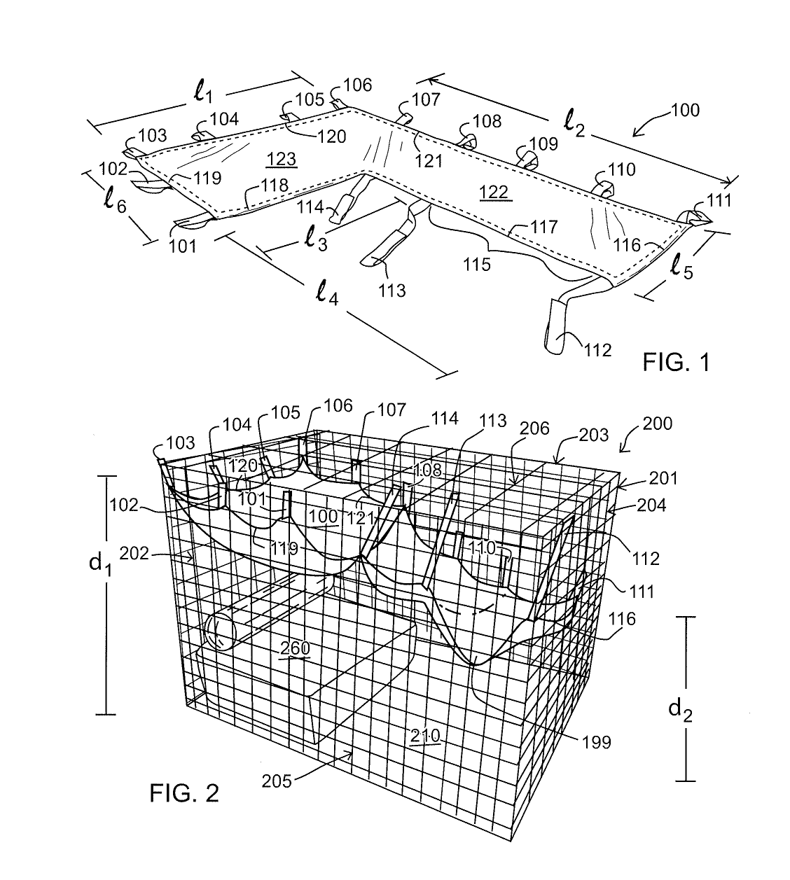

FIG. 1 is a hammock 100 in accordance with an embodiment of the present disclosure. In the embodiment depicted, the hammock is L-shaped. However, other shapes may be used for the hammock 100 in other embodiments. In one embodiment, the hammock 100 is made of a cotton fabric. However, other types of materials may be used in other embodiments.

The hammock 100 comprises six edges 116-121 that form the periphery of the L-shaped hammock. The long L-shape portion 122 comprises edges 116, 117, and 121. Edge 116 is of length l₅ and forms the top edge of the L-shaped hammock 100. Further, edge 117 is the inside edge of the long portion 122 having a length l₄, and edge 121 is the outside edge of the long L-shape portion 122 having a length l₂.

Additionally, the short L-shape portion 123 of the L-shaped hammock comprises edges 118, 119, and 120. Edge 118 is of length l₃ and forms the top edge of the short portion 123 of the L-shaped hammock 100. Further, edge 119 is the outside edge of the short portion 123 having a length l₆, and edge 120 is the bottom edge of the short portion 123 having a length l₁.

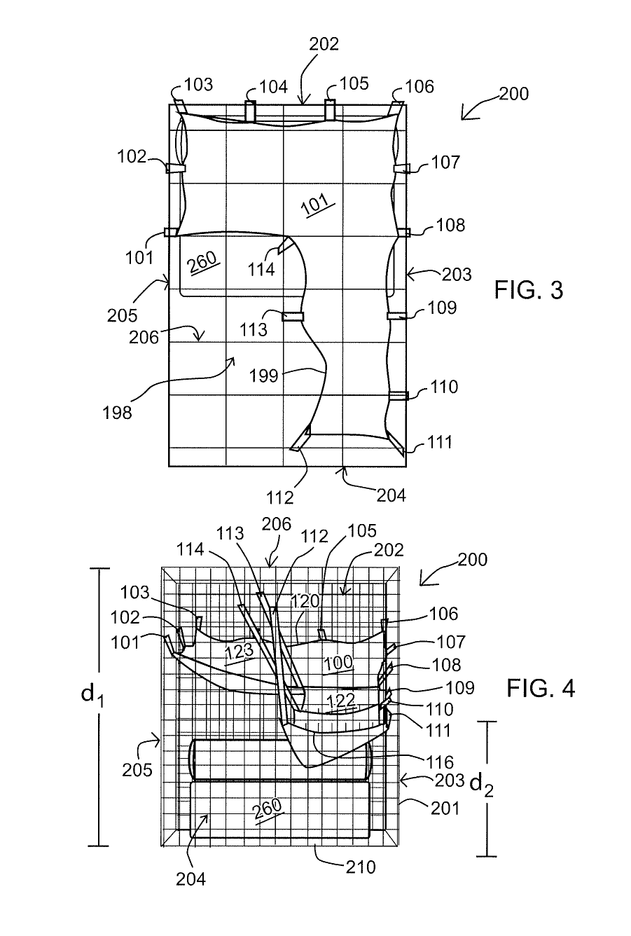

Note that the length l₁ of the edge 120 is longer than the length l₅ of the edge 116. As will be described herein, the difference in the lengths l₁ and e₅ creates a space 198 (shown in FIG. 3 in the top view) that allows a pet an entryway through which the pet can access the hammock 100.

The hammock 100 further comprises a plurality of straps 101-114. In one embodiment, the straps 101-114 comprise Velcro fasteners. However, in another embodiment, the straps 101-114 comprise ties (not shown). Straps 101-111 are substantially equivalent in length. However, straps 112-114 are longer than straps 101-111, which is described further with reference to FIG. 2.

Additionally, between the longer straps 112 and 113 is a strapless section 115. This strapless section 115 forms a declivity and corresponding acclivity when hanging, which forms a droop 199 (shown in FIG. 2) for ingress and egress when the L-shaped member is in a hanging position. This declivity and acclivity forms a droop 199 where the L-shaped member sags, which the pet 250 can use for ingress to and egress from the hammock 101. The term “hanging position” refers to when the L-shaped member is installed in an enclosure, e.g., a cage, as is described with reference to FIG. 2.

In the embodiment depicted in FIG. 1, the hammock 100 is L-shaped. However, the hammock 100 may be other shapes in other embodiments of the present disclosure. As an example, the hammock 100 may be C-shaped or U-shaped. An exemplary hammock 100 may be any shape that does not completely close the hammock 100 off from the lower portion of the cage and comprises a section that provides access to the hammock 100 by the pet.

FIG. 2 is a perspective view of an exemplary pet confinement apparatus 200 comprising the L-shaped hammock 100 in accordance with an embodiment of the present disclosure. The confinement apparatus 200 comprises a cage 201 and a hammock 100. While a cage is the exemplary confinement apparatus shown in FIG. 2, other types of confinement apparatuses may be used in other embodiments. As an example, the confinement apparatus 200 may comprise a crate (not shown) in which is installed the hammock 100.

A description is now made with reference to the installation of the hammock 100. In this regard, the cage 201 has two side members 202 and 204, a front member 205, and a back member 203. Each member 202-205 has a plurality of horizontal and vertical rails. Additionally, the cage 201 has a top member 206 that has a plurality of horizontal and vertical rails.

The bottom edge 120 of the short L-shape portion 123 (FIG. 1) is coupled to three straps 103-106, as described with reference to FIG. 1. The three straps 103-106 are coupled to an upper horizontal rail of the side member 202. The straps 103-106 are coupled to a rail such that the edge 120 of the hammock 100 is a distance d₁ from a floor 210 of the cage 201. Note that the straps 103-106 may be coupled to an uppermost horizontal rail in on embodiment. However, the straps 103-105 may also be coupled to a first or second rail of the side member 202. Thus, as used hereinafter, the term “upper,” “uppermost,” or “top” with reference to rails of the cage may include, for example, any rail above the middle rail on the cage member.

Further, the outside edge 119 of the short L-shaped portion 123 is coupled to two straps 101 and 102, as described with reference to FIG. 1. The two straps 101 and 102 are coupled to an upper horizontal rail of the front member 205. The straps 101 and 102 are coupled at the distance d₁ from the floor 210 of the cage 201. Note that the straps 101 and 102 may be coupled to an uppermost horizontal rail in on embodiment.

Additionally, the inside edge 117 of the long L-shaped portion 122 is coupled to three straps 112-114, which is described with reference to FIG. 1. These straps 112-114 are longer in length than the other straps 101-111, so that the hammock 101 hangs lower in the cage that the bottom edge 120 of the short L-shaped portion 123, thereby allowing a pet ingress to and egress from the hammock 100. The straps 113 and 114 are coupled to a horizontal rail of the top member 206 of the cage 201. Note that in one embodiment, the straps 112-114 are approximately twice the length of the other straps 101-111.

The strap 112 is coupled to a rail so that the upper edge 116 is a distance d₂ from the floor 210. The distance d₂ is shorter than the distance d₁ so that the hammock 100 hangs lower at the side member 204 than it does at side member 202. The strap 112 may be coupled to an upper horizontal rail of the front member 205 or the side member 204. As an example, the strap 112 is shown coupled to a rail of the side member 204 such that the edge 116 is a distance d₂ from the floor 210, which is substantially midway between the floor 210 and the top member 206. In such an embodiment, the distance d₂ is about have the distance of distance d₁. “Midway” refers to a position that corresponds to a middle rail that is between the floor 210 and the top member 206.

In addition, the outside edge 121 of the long L-shaped portion 122 is coupled to the straps 107-111, which is described with reference to FIG. 1. These straps 107-111 are coupled to horizontal rails of the back member 203 of cage 201. These straps are coupled in descending distance from the floor 210 so that the hammock 100 hangs at an angle from the bottom edge 120. This allows room between the top member 206 and the hammock 100 for the pet to sit or lay.

In one embodiment, the confinement apparatus 200 further comprises a bed 260. The bed 260 is positioned on one side of the floor 210. Thus, the pet has three levels that it can occupy, including the floor 210, the bed 260, or the hammock 100.

FIG. 3 is a top view of the confinement apparatus 200 in accordance with an embodiment of the present disclosure. In the embodiment depicted, the hammock 100 is L-shaped, and the L-shape allows for an opening 198 for a pet (not shown) to ingress to and egress from the hammock 100 using the droop 199.

As is described hereinabove, the hammock 100 is coupled to the straps 101-114. Further, the straps 101-114 are coupled to rails of the cage 201. As is seen from the top view, the straps 101 and 102 couple to the front member 205 of the cage. Straps 103-106 couple to the side member 202. Further, straps 107-111 couple to the back member 203, strap 112 couples to the side member 204, and the straps 113 and 114 couple to the top member 206.

FIG. 4 is a side view of the confinement apparatus 200 in accordance with an embodiment of the present disclosure. The side view shown in FIG. 4 is that side to which the long L-shape portion of the hammock 100 is coupled.

As shown in FIG. 4, the bottom edge 120 of the short L-shape portion 123 is coupled to an uppermost rail of the side member 202 via straps 103-106. In this regard, the bottom edge 120 is a distance d₁ from the floor 210.

Further, the top edge 116 of the long L-shape portion 122 hangs approximately midway down from the top member 206. In this regard, the edge 116 is coupled via a short strap 111 to the back member 203 and via the long strap 112 to the side member 202. Note that the strap 112 is longer than the strap 111 so that the hammock 100 hangs down so that a pet can enter the hammock 100 through the opening 198 (FIG. 3) via the droop 199 (FIG. 2).

Note that the confinement apparatus 200 comprises three levels that a pet may use. The first level is the floor 210, the second level is on the bed 260, and the third level is on the hammock 100.

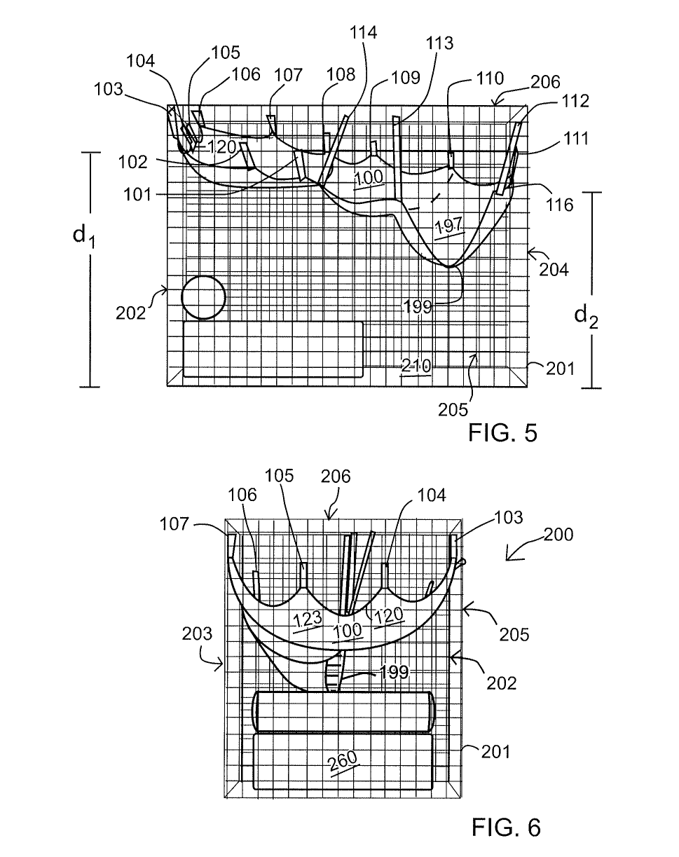

FIG. 5 is a front view of the confinement apparatus 200 in accordance with an embodiment of the present disclosure. The straps 101-106 are coupled to uppermost rails on the front member 205 and the side member 202. The longer straps 113 and 114 are coupled to the top member 206 and allow for the hammock to descend creating the droop 199 which can be used by the pet to ingress to and egress from the hammock 100 via the opening 198.

The bottom edge 121 is a distance d₁ from the floor 210. The top edge 116 is a distance d₂ from the floor 210. The distance d₁ is greater than the distance d₂, and in one embodiment, d₂ is approximate half of the distance d₁. The difference in the distances d1 and d2 provides a space 197 in which the pet may lay.

FIG. 6 is a side view of the confinement apparatus 200 in accordance with an embodiment of the present disclosure. As shown, the straps 103-106 are coupled to an uppermost rail of the side member 202 of the cage 201. Further, the droop 199 hangs below the short L-shape portion 123. The droop 199 allows the pet to ingress to or egress from the hammock 101.

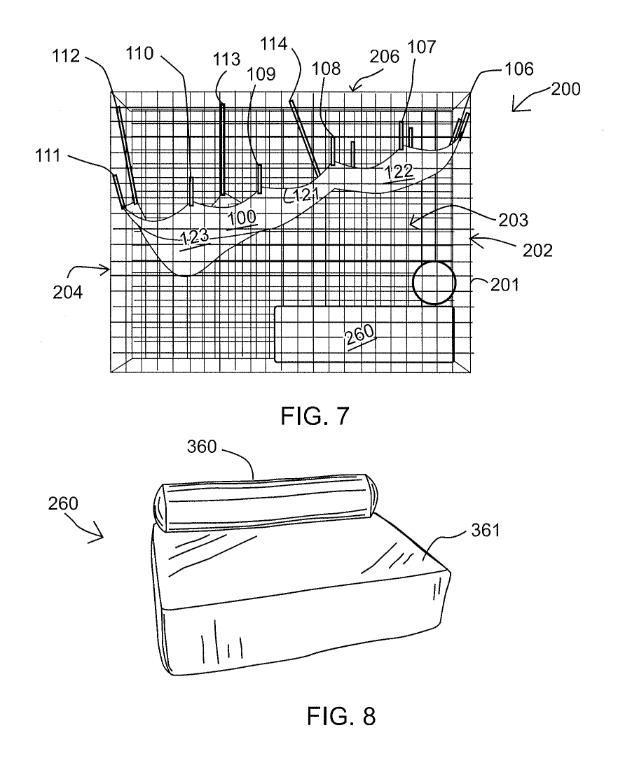

FIG. 7 is a back view of the confinement apparatus 200 in accordance with an embodiment of the present disclosure. Notably, the straps 107-111 are coupled to the top edge 121 of the long L-shape portion 122. Each of the straps 107-111 is coupled on a lower rail than a previous strap. Thus, the hammock 100 descends at an angle, which ensures that the droop (FIG. 6) is at a position reachable by the pet so that the pet can ingress to and egress from the hammock easily. Thus, strap 107 is on an uppermost horizontal rail of the back member 203, strap 108 is on a horizontal rail below the uppermost rails to which strap 107 is coupled. Further, strap 109 is on a horizontal rail below the rail to which strap 108 is coupled, strap 110 is on a horizontal rail below the rail to which strap 109 is coupled, and strap 111 is on a horizontal rail below the rail to which strap 110 is coupled.

FIG. 8 is a perspective view of a bed 260 in accordance with an embodiment of the present disclosure. The bed 260 has a substantially rectangular portion 361. Further the bed 260 has a pillow 360 on a back side of the bed 260. The bed 260 is positioned in the cage 201 (FIG. 2) thereby providing the three levels, including the floor 210, the bed 260, and the hammock 100.

What is claimed is:

1. A pet confinement apparatus, comprising:
a cage having a front member, a back member, a top member, a first and second side member, and a floor, the members and the floor defining a confinement area for confining a pet;
a hammock having a plurality of straps, a portion of the straps coupled to a top horizontal rail of the front member and a top horizontal rail of the first side member, a portion of the straps coupled to the back member and each strap is coupled to a horizontal rail of the back member that is closer to the floor than the horizontal member to which the previous strap is attached, a portion of the straps longer in length that the other straps, at least two of the longer straps coupled to a horizontal rail in the top member so that the hammock hangs forming a declivity and acclivity that allows ingress to and egress from the hammock by the pet.

2. The pet confinement apparatus of claim 1, wherein the hammock is L-shaped.

3. The pet confinement apparatus of claim 2, wherein the L-shaped hammock comprises a long L-shape portion and a short L-shape portion.

4. The pet confinement apparatus of claim 3, wherein the long L-shape portion comprises an outside edge and an inside edge.

5. The pet confinement apparatus of claim 4, wherein the outside edge of the long L-shape portion comprises five back member straps, the outside edge of the long L-shape portion coupled to the back member.

6. The pet confinement apparatus of claim 5, wherein the bottom edge of the short L-shape portion comprises four first side member straps, the bottom edge of the short L-shape portion coupled to the first side member.

7. The pet confinement apparatus of claim 6, wherein the outside edge of the short L-shape portion comprises two front member straps, the outside edge of the short L-shape portion coupled to the front member.

8. The pet confinement apparatus of claim 7, wherein the inside edge of the long L-shape portion comprises at least two straps that are longer in length than the other straps, the inside edge of the long L-shape portion coupled to the top member.

9. The pet confinement apparatus of claim 8, wherein the at least two straps that are separated by a distance greater than a distance of separation between the other straps thereby forming an ingress to and egress from the hammock.

10. A pet confinement apparatus, comprising:
a cage;
a hammock comprising a plurality of straps for coupling the hammock to horizontal rails of the cage, wherein a portion of the straps is longer in length than the other straps thereby forming a droop for ingress to and egress from the hammock.

11. The pet confinement apparatus of claim 10, wherein the hammock is L-shaped.

12. The pet confinement apparatus of claim 11, wherein the portion of the straps that are longer in length are coupled to an inside edge of the long L-shape portion of the hammock.
